(19) United States
(12) Patent Application Publication
(10) Pub. No.: US 2002/0158877 A1
(43) Pub. Date: Oct. 31, 2002

(54) Shadow buffer control module method and software construct for adjusting per pixel raster images attributes to screen space and projector features for digital wrap, intensity transforms, color matching, soft-edge blending and filtering for multiple projectors and laser projectors

(76) Inventors: Ronald James Guckenberger, Longwood, FL (US); Francis James Kane JR., Winter Springs, FL (US)

Correspondence Address: Beusse, Brownlee, Bowdoin & Wolter, P.A., Suite 2500, 390 N. Orange Ave., Orlando, FL, 32801, US

(21) Appl. No.: 09/989,316

(22) Filed: Nov. 20, 2001

Related U.S. Application Data
(60) Provisional application No. 60/252,560, filed on Nov. 22, 2000.

(51) Int. Cl. G06F 13/00

(52) U.S. Cl. 345/536

(57) ABSTRACT

The Shadow Buffer method can be characterized as control of multiple reusable parallel buffers that have utility in mapping digital transformations to improve formation of composite images for single displays or multiple projected images. This method can be described analogously as innovative extensions to current software and hardware solutions that use multiple allocation of pixel memory space to color, alpha and Z-depth functions. The Shadow Buffers are additional pixel and sub-pixel memory maps of screen space and projector attributes (e.g., gamma, contrast, intensity, color, position, stretching, warping, soft-edge blending) that improve the final overall composite image. The improved composite images include but are not limited to:

Multiple Projected Images digitally soft-edge blended into a seamless tiled image displays

Single or Multiple Projected Images digitally warped into a seamless tiled image for curved screen displays

Single or Multiple Projected Images digitally warped for geometric corrections for optical keystone and pin cushion effects.

Single or Multiple Images digitally corrected for defects in the projector or monitor display device

Single or Multiple Images digitally corrected for defects in the display screen(s)

Single or Multiple Images digitally combined or subtracted for sensor fusion, synthetic visions and augmented reality

Further, the parallel nature of the Shadow Buffer supports combinations for custom applications. For example up to the memory limitations of a particular device the Shadow Buffers can be utilized to soft-edge blend, digitally warp projected image tiles and simultaneously corrects for defects in the projector and screen.

Additional combinations and other extensions are obvious to others familiar with the current state of the art.

It is important to emphasize that the Shadow Buffer method is a software construct and method that digitally controls the images within the image generation device and does not require additional custom hardware. Hardware acceleration of the Software Construct and Shadow Buffer Method is possible but not required.

This application claims the benefit of U.S. provisional patent application, serial No. ______ filed Nov. 20, 2001.

### BACKGROUND OF THE INVENTION

“Current digital-based projectors, such as LCD or micro-mirror, provide high luminance at low cost, making them potentially ideal for training simulation. However, their usefulness is greatly limited due to limited adjustability. This limitation also precludes the use of low-cost graphics boards. For instance, dome displays using multiple projectors require warping of the image to correct for distortion at the trainee's eye-point and to stretch the images to eliminate gaps and overlap between the projected images. This necessitates the use of high-cost CRT-based projectors. CRT-based projectors are inherently dim and require expensive replacement of the CRTs as they degrade. As a result, system cost increases due to special hand-worked high-gain screens, and luminance values are less than desired. Light valve-based projectors provide more light, but are very high cost. Current digital-based projectors have some controls, such as optical keystone correction and digital resizing and reformatting. The digital manipulation of the video image could be increased to include useful functions, including the following: 1) regionally controlled image warping to allow distortion correction and edge matching; 2) regionally controlled brightness to allow uniform brightness and edge matching; 3) user-controlled gamma function; 4) user-controlled pixel-based gain to allow for compensation of screen blemishes; and 5) adjustable edge boundary brightness roll-off to allow blending of overlapped projector images.”

This Shadow Buffer development effort provided a solution for the above was funded by a NAWC/TSD SBIR titled: Shadow Buffer Control Module for Digital Warp, Intensity Transforms, and Filtering Advanced Control Features to adapt Low-cost Digital Display Based Projections to Training Simulation and Synthetic Vision applications. The Phase I effort successfully demonstrated the feasibility of the innovative integrated control of a PC-Based Image Generator, a Real-Time Scene Manager, Projectors and Screen Space Attributes by the Shadow Buffer Control Module. A prototype module was utilized to integrate a 6 PC PC-IG configuration on a state-of the-art military visual displays system (i.e., M2DART—See USAF approved Press Release ). The first public display and feasibility demonstration was successfully performed of tiling multiple low-cost anti-aliased visual channels coupled with low-cost high lumen LCD projectors to produce high resolution, high brightness projected displays suitable for use in military simulations and civilian applications (November 2000).

Phase II development of Shadow Buffer products provide advanced control features including edge blending, non-linear geometric distortion correction, uniformity of luminance, and color matching. A design analysis considering all desired system functionality beyond this minimum has been done. Additional capability may be included based on this analysis and the design includes a straightforward upgrade path to incorporate additional functionality. Shadow Buffer capability provide solutions leading to:

Replacement of Legacy Visual Systems—Replace older high cost E&S, SG1 and SE2000 systems with PC-IGs; Replace older high cost, high maintenance CRT and possibly light valve projectors systems by LCD and other next generation digital displays

PC-IG Systems for MiniDART, M2DART Type Displays

Tiling Visual Displays for High Resolution, High Brightness—replacement by

Replacing and Upgrading Visual Systems for Domes

Enhancing Image Generator Workload Management

Enhanced per Pixel Spatial, Color and Temporal real-time manipulation

Digital to Digital Interface

Advanced Automation from a Human Factors basis.

Further, the develop of module algorithms and hardware that supported per pixel post processing of the simulator calculated pixel has numerous applications. Potential applications for the proposed approach of the Shadow Buffer Control Module's utilization of parallel buffers include, but are not limited to:

Sensor Model induced distortions—Example, the granularity or defects of a particular IR sensor

Embedded and Appended Training Modes—Example Shadow Buffers will allow manipulation of LCD displays to specific custom applications including appending to operational equipment vision blocks or mirrored utilization in embedded application.

Sensor Fusion—Example, correlated IR, Radar, and Optical pixels could be blended by the buffers

Synthetic Vision, Example, real-world optical images could be blended with correlated simulated images with the simulated images “filling in the blanks” of weather obscured features. Synthetic Vision Application extend beyond direct training applications into the arena of actual combat operations.

Overlay HUD on legacy vehicles via Synthetic Vision and GPS

Overlay Graphics for Terrain Avoidance

Overlay Warnings of minefields and threat zones

The Shadow Buffer Control Module solution can be characterized analogously as extensions to current software and hardware solutions that use multiple allocation of pixel memory space to color and Z-depth functions. Simulator technology would be advanced by additional buffer spaces for display control. The elegance of having a memory map of screen space attributes (e.g., intensity, position, stretching, warping) upon which to transform the simulator calculated pixels directly supports the concepts of object oriented design and reuse. The natural evolution of software emulation, firmware prototyping and actual hardware implementation was followed. A variety of displays were utilized including but not limited to monitors, HMDs (by Virtual Research or Sony), flat panels, CRT & LCD projectors, M2DART Variants and Domes.

The key concept is reusable parallel buffers that have utility in mapping digital transformations required by the scene manager, image generator, actual display devices, and screen attributes. For example, one buffer can contain the screen space per pixel modifications needed to blend two projected visuals channels into a seamless mesh, while another buffer for the projector space attributes applies per pixel transforms to correct for the dynamic range limitations of that particular projector.

The shadow buffer key concept was developed, optimized, prototyped, and integrated into a digitally controlled high fidelity simulator testbed. To emphasize the significance and importance of the Shadow Buffer Control Module the first Phase II task substituted for a $500,000 visual display system in a high fidelity military simulator with an equivalent Shadow Buffer Controlled $100,000 visual system.

The advanced state of the Phase I prototype was able to support the USAF Simulation Certification of Shadow Buffer System in 2000. Initial saving to this one program planned at 16 systems could be $6 Million with greatly reduced lifecycle costs.

Other POTENTIAL PROGRAM TRANSITIONS

US Navy Shipboard Visuals for Simulation, low cost & small footprint—Reconfigurable Flight Simulator Example

US Navy Curved Screen Projector Replacement (Potential Light Valve Replacement)

US Navy Dome display systems upgrades & new designs using low cost PC based graphics & low cost digital projectors

Extremely high resolution across large field of view displays for Command/Control

US Marine INDOOR SIMULATED MARKSMANSHIP TRAINER-ENHANCED planned program that would benefit from the Shadow Buffer Control Module (Dual Projector Higher Resolution and Redundancy Concept)

US Army EST (Dual Projector Higher Resolution and Redundancy Concept)

USAF A-10 Program (5 & 9 Channel Systems)

USAF DMT (M2DART) Program (6 & 8 Channel systems)

T&E Follow-On Program (Matching Eglin T&E Funds)

Cross Service Appended DMT M2DART Visuals for Actual Aircraft

Commercial Sony Digital Magic Theaters

Prior Art practitioners typically modify the image generator output analog signals with dedicated hardware between the image generator and the projector. This dedicated hardware approach is costly, device dependent and typically suffers from some form of analog uncertainty. The MetaVision and Seos devices work in this fashion by alteration of the image generator analog output prior to the signal being input to the projector. Similarly, video mixers typically combine several analog signals for video walls, picture in a picture and superimposed images.

Shadow Buffer Method and Software Construct for Adjusting Per Sub-Pixel Raster Images Attributes to Screen Space and Projector Features for Digital Warp, Intensity Transforms, Color Matching, Soft-Edge Blending and Filtering for Displays, Multiple Projectors and Laser Projectors

Shadow Buffer Software Construct and Method

The Shadow Buffer method can be characterized as control of multiple reusable parallel buffers that have utility in mapping digital transformations to improve formation of composite images for single displays or multiple projected images. This method can be described analogously as innovative extensions to current software and hardware solutions that use multiple allocation of pixel memory space to color, alpha and Z-depth functions. The Shadow Buffers are additional pixel and sub-pixel memory maps of screen space and projector attributes (e.g., gamma, contrast, intensity, color, position, stretching, warping, soft-edge blending) that improve the final overall composite image.

The improved composite images include but are not limited to:

Multiple Projected Images digitally soft-edge blended into a seamless tiled image displays

Single or Multiple Projected Images digitally warped into a seamless tiled image for curved screen displays

Single or Multiple Projected Images digitally warped for geometric corrections for optical keystone and pin cushion effects.

Single or Multiple Images digitally corrected for defects in the projector or monitor display device

Single or Multiple Images digitally corrected for defects in the display screen(s)

Single or Multiple Images digitally combined or subtracted for sensor fusion, synthetic visions and augmented reality

Further, the parallel nature of the Shadow Buffer supports combinations for custom applications. For example up to the memory limitations of a particular device the Shadow Buffers can be utilized to soft-edge blend, digitally warp projected image of integrated tiles and simultaneously correct for defects in the projector and screen.

Additional combinations and other extensions are obvious to practitioners familiar with the current state of the art.

It is important to emphasize that the Shadow Buffer method is a software construct and method that digitally controls the images within the image generation device and does not require additional custom hardware. Hardware acceleration of the Software Construct and Shadow Buffer Method is possible but not required.

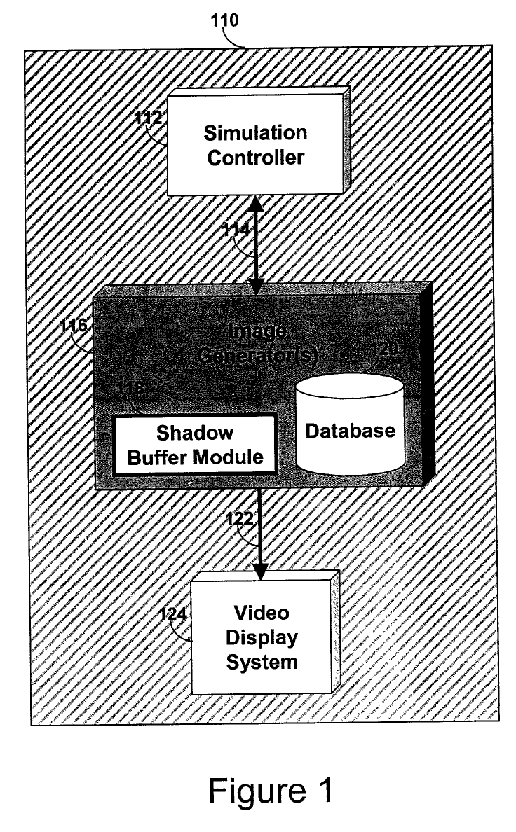

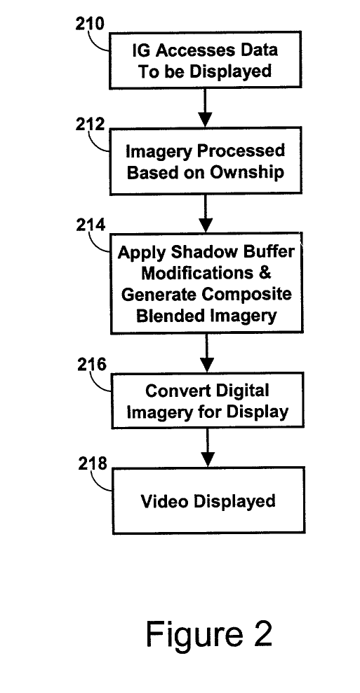

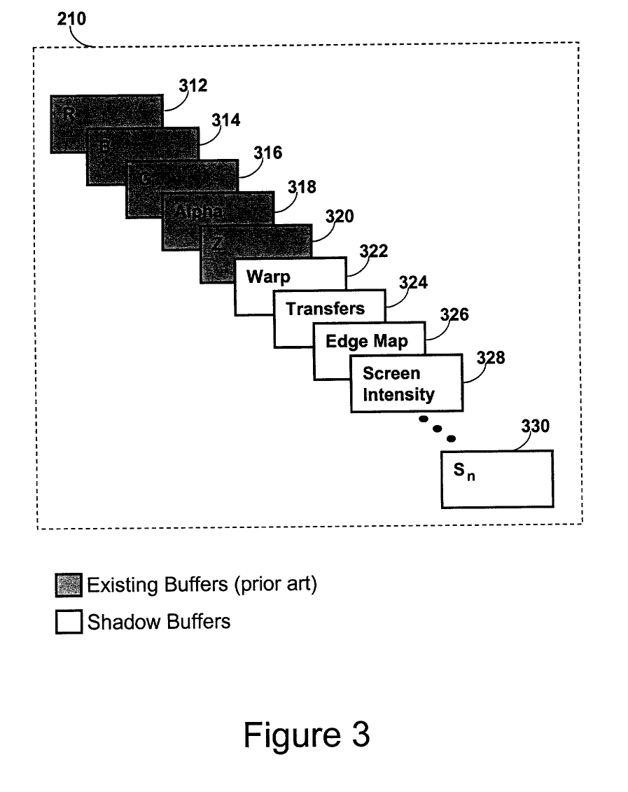

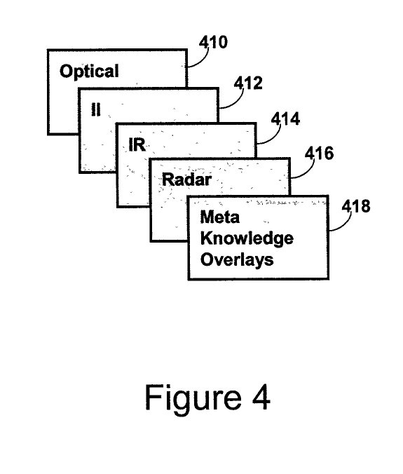

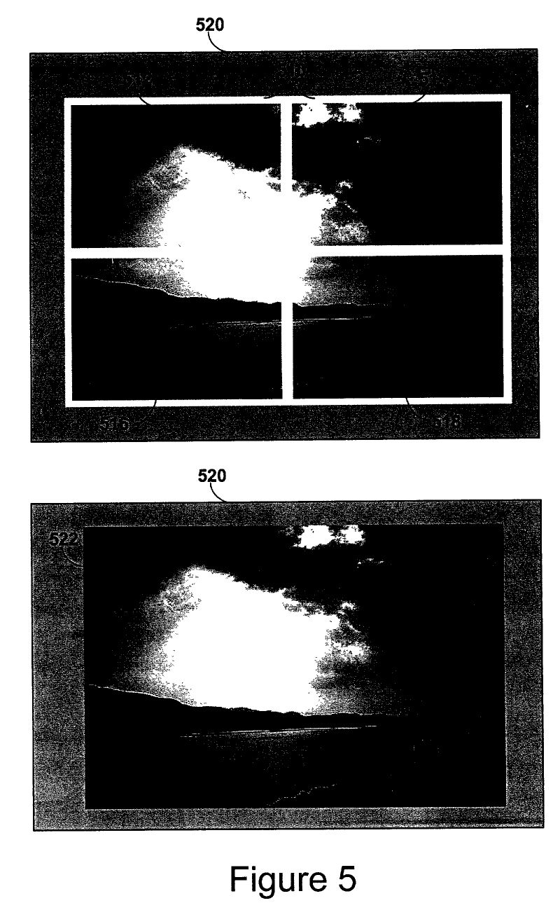

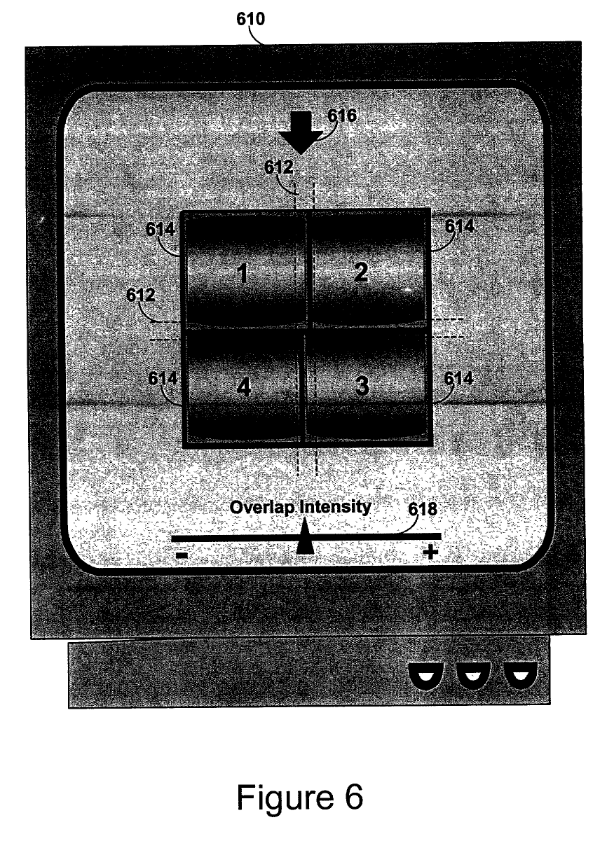

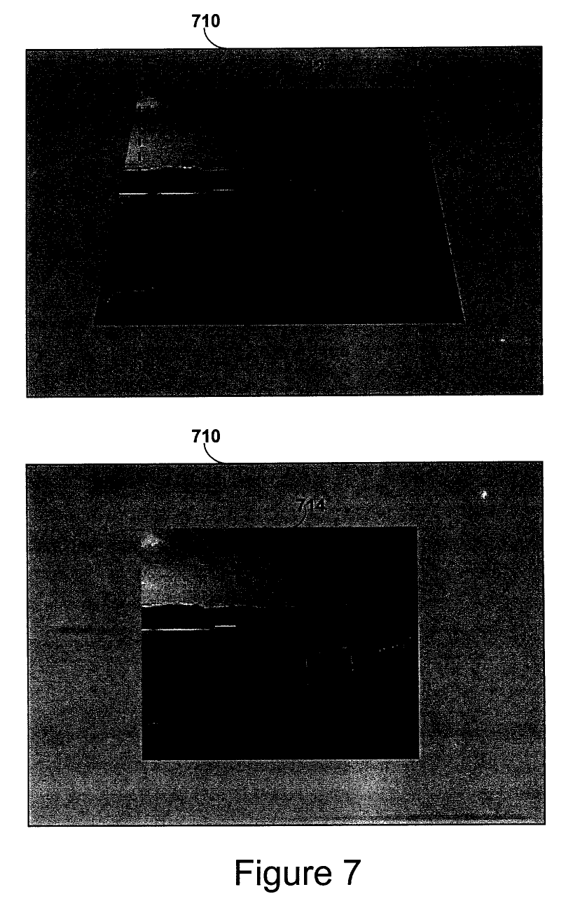

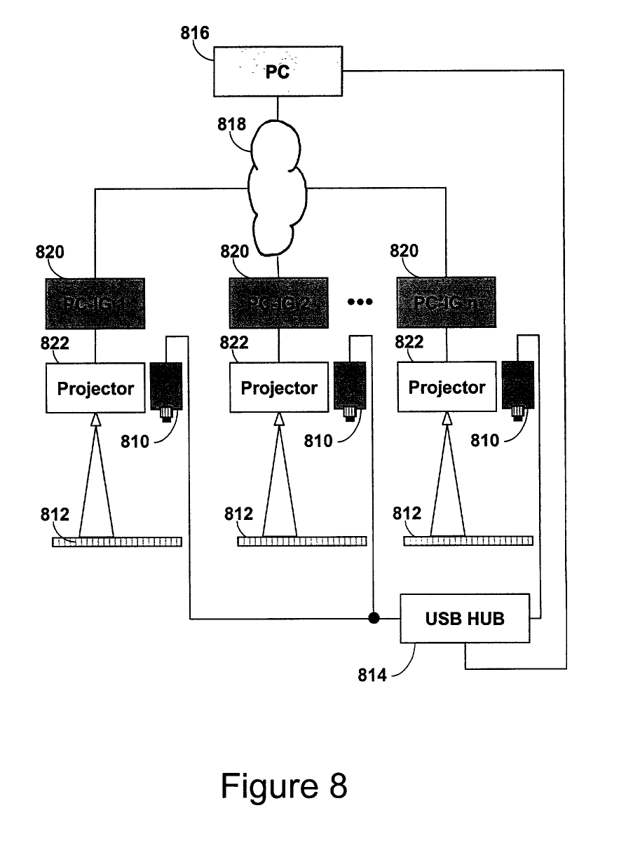

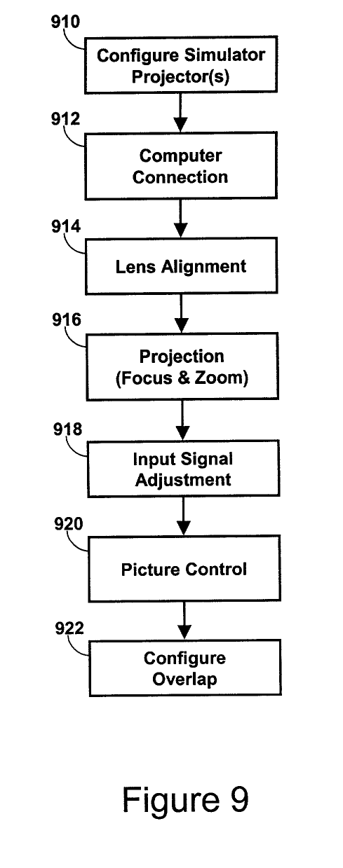

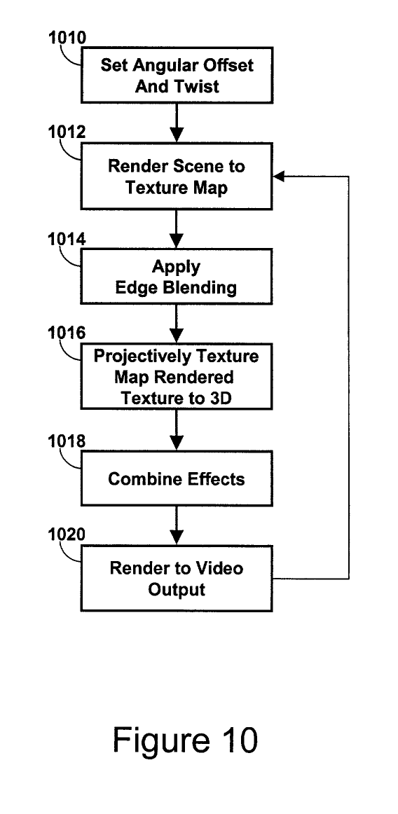

See FIG. 1 below for a high level illustration of the Shadow Buffer Memory Space Concepts as applied to screen space attributes.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A system for adjusting digitally generated images for single monitors, single projectors and arrays of monitors, and projectors of raster images to form composite blended images from multiple frame buffer inputs comprising:
single or multiples of monitors including CRTs, flat screens, and projectors and their associated displays, to form blended composite images; a plurality of projectors to display the array of raster images, each raster image including red, green and blue color components, to form a blended composite projected image;
a N dimensional array of shadow buffers, each shadow buffer value being associated with a sub-pixel, pixel, region of each input memory value blended into the entire composite image; and
means for applying the shadow buffer values to the digital image prior to output as video signals or digital packets to blend multiple digital inputs and frame buffer memory values into a blended composite image, wherein the shadow buffer values comprises alterations and modifications to for each image pixel displayed of the blended composite image for each of red, green, and blue color displayed frame buffer pixel value, and wherein each shadow buffer value is applied to a selected portion of the blended composite image by addition, subtracting, shifting, masking of bits, or colors, scaling, accumulation, logical and bit-wise operations the shadow buffer values with input frame buffer values for the selected portion.

2. The system of claim 1, wherein the applying means comprises means for blending and or superimposing multiple digital inputs into a single blended image, each layer of the resultant image can be brightened or dimmed for emphases or reduction of visible contribution. This blended image methodology improves sensor fusion, synthetic vision applications and augmented reality applications.

3. The system of claim 1, wherein the applying means comprises means for blending real-time video and or sensor image digital inputs while simultaneously superimposing photo-realistic, geo-specific synthetic vision computer generated simulated visuals and or sensor images into a single blended image, each layer of the resultant image can be brightened or dimmed for emphases or reduction of visible contribution.

4. The system of claim 1, wherein the applying means comprises means for surrounding the blended sensor fusion, synthetic vision applications and augmented reality display with additional synthetic vision displays to increase situational awareness by increasing the apparent Field Of View (FOV). This methodology is particularly valuable for Unmanned Aerial Vehicle Electro-Optical Pod Controllers.

5. A system for adjusting digitally generated images for single monitors, single projectors and arrays of monitors, and projectors of raster images to compensate for projection and screen defects and or blended images comprising:
single or multiples of monitors including CRTs, flat screens, and projectors and their associated display screens, to form blended or composite images;
a plurality of projectors to display the array of raster images, each raster image including red, green and blue color components, to form a composite projected image;
a N dimensional array of shadow buffers, each shadow buffer value being associated with a sub-pixel, pixel, region or the entire composite projected image; and
means for applying the shadow buffer values to the digital image prior to output as video signals or digital packets to remove the projection and screen defects resulting from display of the array of raster images, wherein the shadow buffer values comprises alterations and modifications to for each image pixel displayed of the composite projected image for each of red, green, and blue color displayed frame buffer pixel value, and wherein each shadow buffer value is applied to a selected portion of the composite projected image by addition, subtracting, shifting, masking of bits, or colors, scaling, accumulation, logical and bit-wise operations the shadow buffer values with displayed frame buffer values for the selected portion.

6. The system of claim 5, wherein the applying means comprises means for soft edge blending of adjacent overlapping raster images for arrays including horizontal, vertical and tiled configurations.

7. The system of claim 5, wherein the applying means comprises means for soft edge blending of adjacent overlapping raster images for arrays including horizontal, vertical and tiled configurations.

8. The system of claim 5, wherein the applying means comprises means for matching color outputs of the projectors displaying the array of raster images.

9. The system of claim 5, wherein the applying means comprises means for correcting occurrences of improper projector shading for the projectors by applying the shadow buffer values.

10. The system of claim 5, wherein the applying means comprises means for correcting occurrences of horizontal, vertical, or geometric color purity shifts for the projectors by adjusting the brightness of the composite projected image according to the shadow buffer values.

11. The system of claim 5, wherein the applying means comprises means for correcting occurrences of optical keystone and pin cushion effects for the projectors by masking the edges and adjusting the color space contributions with spatial alterations for the remaining pixels of the columns and/or rasters that have been shortened of the composite projected image according to the shadow buffer values.

12. The system of claim 5, wherein the applying means comprises means for applying the shadow buffer values per sub-pixel or pixel linearly and non-linearly to adjust selected portions of the composite projected image which are brighter to be diminished more strongly than selected portions of the composite projected image which are darker, thereby adjusting the value of the smoothing factors based on a variable intensity of the video signals for the selected portions.

13. The system of claim 5, wherein the applying means comprises means for altering edges of the composite projected image when the composite projected image is not square or rectangular in shape and for displaying the composite projected image within the determined display edges.

14. A system for adjusting video signals representing an array of raster images to compensate for projection defects and screen defects comprising:
a plurality of projectors to display the array of raster images, each raster image including red, green and blue color components, to form a composite projected image;
means for storing N dimensional arrays of shadow buffer values, each shadow buffer value being associated with a portion of the composite projected image; and
means for applying the shadow buffer values to the digital image prior to output as video signals or digital packets to remove the projection and screen defects resulting from display of the array of raster images, wherein the applying means comprises:
an intensity shadow buffer array comprised of sub-pixel or pixel values that digitally adjusts the associated image pixel values by addition, subtracting, shifting, masking of bits, or colors, scaling, accumulation, logical and bit-wise operations prior to output;
a gamma shadow buffer array comprised of sub-pixel or pixel values that digitally adjusts the associated image pixel values by addition, subtracting, shifting, masking of bits, or colors, scaling, accumulation, logical and bit-wise operations prior to output;
a color space shadow buffer array comprised of sub-pixel or pixel values that digitally adjusts the associated image pixel color values by addition, subtracting, shifting, masking of bits, or colors, scaling, accumulation, logical and bit-wise operations prior to output; and
a geometry correction shadow buffer array comprised of sub-pixel or pixel values that digitally adjusts the associated image pixel column or raster lengths via a shadow buffer edge mask coupled with a redistributes of the masked pixels values across the remaining displayed pixels.

15. The system of claim 14, further comprising a gamma correction method coupled to the multiple shadow buffers to adjust the gamma prior to output of the video signals and digital outputs.

16. The system of claim 14, further comprising a intensity correction method coupled to the multiple shadow buffers to adjust the intensity prior to output of the video signals and digital outputs.

17. A method of matching arrayed projectors to produce a composite raster image having consistent green, red, and blue color values, comprising the steps of:
(a) focusing at least one digital camera or light sensor on the display(s) or projection screen(s);
(b) displaying green color values by a selected one of the displays or projectors on the display(s) or projection screen(s);
(c) displaying bars or grayscale patterns, etc. of the green color values by the selected display or projector on the display(s) or projection screen(s);
(d) collecting green performance measurement data from the at least one digital camera or light sensor sensing the display by the selected display(s) or projection screen(s);
(e) displaying red color values by a selected one of the displays or projectors on the display(s) or projection screen(s);
(f) displaying bars or grayscale patterns, etc. of the red color values by the selected display or projector on the display(s) or projection screen(s);
(g) collecting red performance measurement data from the at least one digital camera or light sensor sensing the display by the selected display(s) or projection screen(s);
(h) displaying blue color values by a selected one of the displays or projectors on the display(s) or projection screen(s);
(i) displaying bars or grayscale patterns, etc. of the blue color values by the selected display or projector on the display(s) or projection screen(s);
(j) collecting blue performance measurement data from the at least one digital camera or light sensor sensing the display by the selected display(s) or projection screen(s);
(k) displaying grayscale color values by a selected one of the displays or projectors on the display(s) or projection screen(s);
(l) displaying bars or grayscale patterns, by the selected display or projector on the display(s) or projection screen(s);
(m) collecting grayscale performance measurement data for contrast and dynamic range from the at least one digital camera or light sensor sensing the display by the selected display(s) or projection screen(s);
(n) repeating steps (b)-(m) for each of the display(s) or projection screen(s);
(o) generating a performance profile for each of the display(s) or screen projection and for all projectors combined from the collected measurement data;
(p) adjusting the projectors according to the performance profiles, via digital controls from a shadow buffer control module ( * * * Separate provisional patent application) and
(q) adjusting the associated shadow buffer according to the performance profiles, via digital controls from a shadow buffer control module ( * * * Separate provisional patent application) wherein the composite rater image comprises a plurality of raster images, each of the plurality of raster images includes red, green and blue color components, and each raster image is displayed on single or multiple displays, tiled flat panels, and or projected on a projection screen by one of the arrayed projectors.

18. The method of claim 17, further comprising the steps of:
(r) analyzing entire area of each projector's projected raster image;
(s) calculate per pixel changes to the shadow buffers based upon the performance profile;
(t) applying the calculated per pixel values to the shadow buffers to the composite raster image.

19. The method of claim 18, wherein the shadow buffers comprises an N dimension dimensional array of parallel buffers.

20. A system for producing a composite raster image having consistent dynamic range for the system comprising:
arrayed projectors to project the composite raster image on a projection screen;
at least one digital camera or one light sensor sensing the composite raster image on the projection screen;
means for displaying selected color values by selected projectors on the projection screen;
means for displaying patterns of selected color values by selected projectors on the projection screen;
means for collecting measurement data from the at least digital camera or one light sensor sensing the display by the selected projector of the patterns;
means for generating a dynamic range performance profile for each of the projectors and for all projectors combined from the collected measurement data; and
means for adjusting the projectors according to the dynamic range performance profiles, wherein the composite raster image comprises a plurality of raster images, each of the plurality of raster images includes various dynamic range performance, and the arrayed protectors are matched to provide the consistent dynamic range performance values to the composite raster image.

21. The system of claim 20, further comprising:
means for generating a color performance profile for each of the projectors and for all projectors combined from the collected measurement data; and
means for adjusting the projectors according to the color performance profiles.

22. The system of claim 20, further comprising:
means for generating a gamma performance profile for each of the projectors and for all projectors combined from the collected measurement data; and
means for adjusting the projectors according to the gamma performance profiles.
